(19) United States
(12) Patent Application Publication
(10) Pub. No.: US 2025/0346514 A1
(43) Pub. Date: Nov. 13, 2025

(54) WATER TREATMENT SYSTEM AND WATER TREATMENT METHOD

(71) Applicant: ORGANO CORPORATION, Tokyo (JP)

(72) Inventors: Keisuke SASAKI, Tokyo (JP); Yuki NAKAMURA, Tokyo (JP); Keigo SATO, Tokyo (JP)

(73) Assignee: ORGANO CORPORATION, Tokyo (JP)

(21) Appl. No.: 18/994,169

(22) PCT Filed: Jul. 20, 2023
(86) PCT No.: PCT/JP2023/026652

§ 371 Date: Jan. 14, 2025

(30) Foreign Application Priority Data
Aug. 31, 2022 (JP) 2022-138237

(51) Int. Cl. C02F 9/00; B01D 61/02; B01D 61/48; B01D 61/58; C02F 1/44; C02F 1/469; C02F 101/10; C02F 103/04; C02F 103/34

(52) U.S. Cl. CPC C02F 9/00; B01D 61/58; B01D 61/026; B01D 61/48; B01D 2317/025; B01D 2317/08; C02F 1/441; C02F 1/4695; C02F 2101/108; C02F 2103/04; C02F 2103/346; C02F 2301/08

(57) ABSTRACT

A water treatment system for removing at least boron from treated water includes RO membrane devices that include an extra low-pressure RO membrane, and EDI devices that are arranged to follow the RO membrane devices and that include an EDI stack for high purity in which at least an anion exchange resin fills a bottom layer of a desalination chamber and at least a cation exchange resin fills an adjacent concentration chamber via a cation exchange membrane that partitions the desalination chamber, wherein the RO membrane devices are RO membrane devices in two stages, and an extra low-pressure RO membrane is arranged in at least one of the first and second stages.

### TECHNICAL FIELD

This invention relates to a water treatment system and a water treatment method.

### BACKGROUND OF ART

Pure water (including ultrapure water) from which contaminants such as organic matter, ionic components, particulates, and bacteria have been largely eliminated is used as cleaning water in the process of producing semiconductor devices and liquid crystal devices. In particular, the water quality requirements for pure water used in the cleaning process of electronic components, including semiconductor devices, have been increasing year by year. In recent years, one of these requirements has been to improve the removal rate of boron from pure water. The use of reverse osmosis membrane devices (hereinafter referred to as RO membrane devices) and electro-deionization deionized water production devices (hereinafter referred to as EDI devices) are known to be capable of removing boron, which is a weak acid component (see, for example, Patent Document 1). In some cases, high-pressure RO membrane devices are used to achieve high boron removal rates (see, for example, Patent Document 2). Adjusting the pH of the water supplied to an RO membrane device to the alkaline side is also known as a method that can improve the boron removal efficiency.

### PRIOR ART DOCUMENTS

### Patent Documents

Patent Document 1: JP 4045658
Patent Document 2: JP 5733351

### SUMMARY OF THE INVENTION

### Problem to be Solved by the Invention

The removal rate of boron through the use of RO membranes is low, ranging from 45 to 60% in the neutral range, even when an ultra-low pressure RO membrane is used. In contrast, using a high-pressure type RO membrane increases the boron removal rate to a range of 80 to 90%, but this method also leads to increased pump power consumption. Adjusting the pH of the water supplied to the RO membrane to 9 or more on the alkaline side improves the boron removal rate but also requires chemical injection facilities and chemical replenishment management, resulting in increased management costs. The addition of alkali also accelerates the degradation of an RO membrane, raising the concern that RO membranes will need to be replaced more frequently.

The above-described techniques therefore do not allow improvement of the boron removal rate without entailing significant drawbacks.

The purpose of the present invention is to provide a water treatment system and a water treatment method that can improve the boron removal rate without entailing significant disadvantages.

### Means for Solving the Problem

A water treatment system of the present invention is a water treatment system for removing at least boron from treated water, comprising:
an RO membrane device that includes an extra low-pressure RO membrane; and,
an EDI device that is arranged to follow the RO membrane device and that includes an EDI stack for high purity in which a lowermost layer of a desalination chamber is filled with at least an anion exchange resin and an adjacent concentration chamber via a cation exchange membrane that partitions the desalination chamber is filled with at least a cation exchange resin, wherein
the RO membrane device includes RO membrane devices in two stages and the extra low-pressure RO membrane is arranged at least in one of the first and second stages.

The water treatment method of the present invention is a water treatment method for removing at least boron from treated water, the method comprising:
operating RO membrane devices that include an extra low-pressure RO membrane device installed to precede an EDI device that includes an EDI stack for high purity such that the boron concentration of treated water supplied to the EDI device is from 20 to 100 μg/L, the silica concentration is 50 μg/L or less, and the hardness is 0.05 mg CaCO3/L or less.

### Advantageous Effects of the Invention

In this invention, the boron removal rate can be improved without significant disadvantages.

### BRIEF DESCRIPTION OF THE DRAWINGS

FIG. 1 is a diagram showing a first embodiment of a water treatment system of the present invention.

FIG. 2 is a diagram showing an example of the structure of the EDI device shown in FIG. 1.

FIG. 3 is a diagram showing a second embodiment of a water treatment system of the present invention.

FIG. 4 is a diagram showing an example of the structure of the EDI device for general use shown in FIG. 3.

FIG. 5 is a diagram showing a third embodiment of a water treatment system of the present invention.

FIG. 6 is a diagram showing a fourth embodiment of a water treatment system of the present invention.

FIG. 7 is a diagram showing a first comparative example for comparison with the embodiments.

FIG. 8 is a diagram showing a second comparative example for comparison with the embodiments.

FIG. 9 is a diagram showing an example of a pump arrangement in a water treatment system of the present invention.

FIG. 10 is a diagram showing pressure values at each point in the embodiment shown in FIG. 3.

FIG. 11 is a diagram showing another example of the structure of an EDI device for high purity used in the present invention.

### DESCRIPTION OF THE EMBODIMENTS

The WHO Guidelines for drinking water quality (Guidelines for drinking-water quality: fourth edition incorporating the first and second addenda, 4th edition+1st addenda+2nd addenda. World Health Organization) report that the concentration of boron in drinking water in most parts of the world is less than 0.5 mg/L. Furthermore, the average value in the water quality distribution table (raw water) of the Japan Water Works Association's Water Quality Database (2018) (http://www.jwa.or.jp/mizu/) is 99% for surface water and 97% for ground water at points where the concentration of boron and its compounds is 0.1 mg/L or less. Based on these considerations, the boron concentration range of raw water to which this invention is applied is assumed to be a range from 0.01 to 0.2 mg/L, and preferably from 0.02 to 0.1 mg/L.

Embodiments of the invention are next described with reference to the drawings. This invention is a water treatment system that removes at least boron from treated water using RO membrane (reverse osmosis membrane) devices and EDI devices (electro-deionization deionized water production devices) connected in series with each other. The EDI devices are arranged to follow the RO membrane devices. The EDI devices combine electrophoresis and electrodialysis. The EDI devices each consist of a desalination chamber between an anode and cathode, the desalination chamber being partitioned by a pair of ion-exchange membranes. At least the desalination chamber in each EDI device is filled with an ion exchange resin. Treated water passes through the desalination chamber with DC voltage applied between the anode and cathode whereby the treated water is subjected to a desalination treatment in the desalination chamber, and treated water from which ionic components have been removed then flows from the desalination chamber. The RO membrane devices are of a two-stage configuration (RO membrane devices in two stages). This two-stage configuration of the RO membrane devices may be, for example, a two-stage configuration including an extra low-pressure RO membrane device and another extra low-pressure RO membrane device, a two-stage configuration including an ultra-low pressure RO membrane device and an extra low-pressure RO membrane device, or a two-stage configuration in which one of the two stages is an extra low-pressure RO membrane device and the other is a different RO membrane device such as a low-pressure RO membrane device. The water is divided into a number of categories according to the configuration of the RO membrane devices, the quality of the feed water supplied to the EDI devices being set for each of the categories. The parameters of the water quality of the feed water (treated water from the RO membrane devices) to the EDI devices for each category are shown in Table 1.

TABLE 1

| | | Conductivity | Boron | Sodium | Silica | Hardness |
|---|---|---|---|---|---|---|
| Category | RO system | (μS/cm) | (mg/L) | (mg/L) | (mg/L) | (mgCaCO₃/L) |
| A | Extra low- | 3~4 | 0.10~0.12 | 0.5~0.6 | 0.04~0.06 | 0.04~0.05 |
| | pressure RO | | | | | |
| | →Extra low- | | | | | |
| | pressure RO | | | | | |
| B | Ultra-low | 2~3 | 0.02~0.03 | 0.2~0.3 | 0.00~0.02 | 0.02~0.03 |
| | pressure RO | | | | | |
| | →Extra low- | | | | | |
| | pressure RO | | | | | |
| C | Low-pressure RO | 1~2 | 0.005~0.01 | 0.1~0.15 | <0.005 | <0.01 |
| | →Ultra-low | | | | | |
| | pressure RO | | | | | |
| | (Add alkali) | | | | | |

As shown in Table 1, for a case in which the RO membrane devices are configured such that an extra low-pressure RO membrane device is arranged to follow an extra low-pressure RO membrane device, the feed water supplied to the EDI devices is classified as Category A. For a case in which the RO membrane devices are configured such that an extra low-pressure RO membrane device is arranged to follow an ultra-low pressure RO membrane device, the feed water supplied to the EDI devices is classified as Category B. For case in which the RO membrane devices are configured such that an ultra-low pressure RO membrane device is arranged to follow a low-pressure RO membrane device, the feed water supplied to the EDI devices is classified as Category C. Category A supply water has conductivity of from 3 to 4 μS/cm, a boron concentration of from 0.10 to 0.12 mg/L, a sodium concentration of from 0.5 to 0.6 mg/L, a silica concentration of from 0.04 to 0.06 mg/L, and hardness of from 0.04 to 0.05 mgCaCO₃/L. Category B supply water has conductivity of from 2 to 3 μS/cm, a boron concentration of from 0.02 to 0.03 mg/L, a sodium concentration of from 0.2 to 0.3 mg/L, a silica concentration of from 0.00 to 0.02 mg/L, and hardness of from 0.02 to 0.03 mgCaCO 3/L. Category C supply water has conductivity of from 1 to 2 μS/cm, a boron concentration of from 0.005 to 0.01 mg/L, a sodium concentration of from 0.1 to 0.15 mg/L, a silica concentration less than 0.005 mg/L, and hardness less than 0.01 mgCaCO₃/L.

When the concentration of boron in raw water supplied to the first-stage RO membrane device is 0.1 mg/L, the boron removal rate in the Category A configuration is 0%, the boron removal rate in the Category B configuration is 70 to 80%, and the boron removal rate in the Category C configuration is 90 to 95%. When the concentration of boron in raw water supplied to the first-stage RO membrane device is 0.2 mg/L, the boron removal rate in the Category A configuration is 40 to 50%, the boron removal rate in the Category B configuration is 85 to 90%, and the boron removal rate in the Category C configuration is 95 to 98%. For the Category C configuration, a system was assumed in which alkali is added to the feed water line of the first-stage low-pressure RO to adjust the pH at the outlet of the concentrated water to from 10 to 11.

Here, the extra low-pressure RO membrane equipped in the extra low-pressure RO membrane device is a membrane that has a salt removal rate of less than 99.4%, and a permeate flow rate (permeate flow rate per unit pressure and unit area) per 1 MPa of supply pressure and 1 m² of membrane area of 1.3 (m³/d)/(m². MPa) or more measured under the following conditions: the supplied raw liquid has a NaCl concentration of from 500 to 2000 mg/L, a pH value of from 6 to 8, a water temperature of 25° C., and a permeate recovery rate of from 10 to 25%. Under the above test conditions, if the supply pressure is 0.86 MPa, the permeate flow rate is 53 m³/d, and the membrane area is 41 m², the permeate flow rate per 1 MPa of supply pressure and membrane area of 1 m² is 53/(41×0.86)=1.50 (m³/d)/(m²·MPa). extra low-pressure RO membranes include, for example, XLE-440 and XLE-440i produced by Dupont, ESPA4 (ESPA4-LD-4040, ESPA4-LD, ESPA4-LD HP, and ESPA4MAX) produced by Hydranautics, and TMHA (TMH10A, TMH20A-400C, and TMH20A-400C) produced by Toray Industries, Inc. Ultra-low pressure RO membranes refer to membranes with a permeate flow rate per unit pressure and unit area of less than 1.3 (m³/d)/(m²·MPa) and a salt removal rate of 99.3% or higher under the same test conditions as above. Ultra-low pressure RO membranes include, for example, BW30HRLE-440 and SG30LE-440i produced by Dupont, ESPA2 MAX produced by Hydranautics, and TMG20D-400 produced by Toray Industries, Inc. Low-pressure RO membranes refer to membranes with a permeate flow rate per unit pressure and unit area of 0.8 (m³/d)/(m² MPa) or less and a salt removal rate of 99.5% or higher under the same test conditions as above. An example of a low-pressure RO membrane is CR100 produced by Dupont.

### First Embodiment

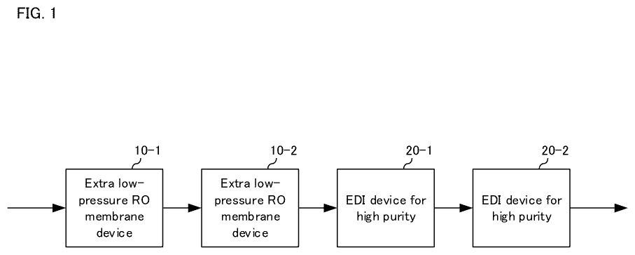

FIG. 1 is a diagram showing a first embodiment of a water treatment system of the present invention. In this embodiment, RO membrane devices 10-1 and 10-2 and EDI devices 20-1 and 20-2 are connected in series as shown in FIG. 1. Each of RO membrane devices 10-1 and 10-2 is an extra low-pressure RO membrane device equipped with an extra low-pressure RO membrane. EDI devices 20-1 and 20-2 are EDI devices for high purity. Raw water is supplied to RO membrane device 10-1 shown in FIG. 1, and the supplied raw water is treated in each of RO membrane devices 10-1 and 10-2 and EDI devices 20-1 and 20-2.

In this case, an EDI device for high purity is an EDI device that processes permeate water treated by two stages of RO membranes (thus having a boron concentration of 0.01 to 0.20 mg/L and water temperature of 20 to 28° C.) and has a boron removal rate of 99.0% or higher. If an extra low-pressure RO membrane device is installed preceding the EDI device, the boron removal rate of the RO membrane device is considered to be lower than a case in which an ultra-low pressure, low-pressure, or high-pressure RO membrane device is installed. Therefore, EDI devices 20-1 and 20-2 that include EDI stacks for high purity are installed as the EDI devices that follow RO membrane devices 10-1 and 10-2. The lowermost layer of the desalination chamber of each of the EDI devices for high purity is filled with at least an anion exchange resin, and more preferably is filled with a single bed of anion exchange resin. Furthermore, a concentration chamber adjacent to the desalinization chamber via a cation exchange membrane that partitions the desalinization chamber is filled with at least a cation exchange resin, and more preferably is filled with a mixed bed of anion exchange resin and cation exchange resin.

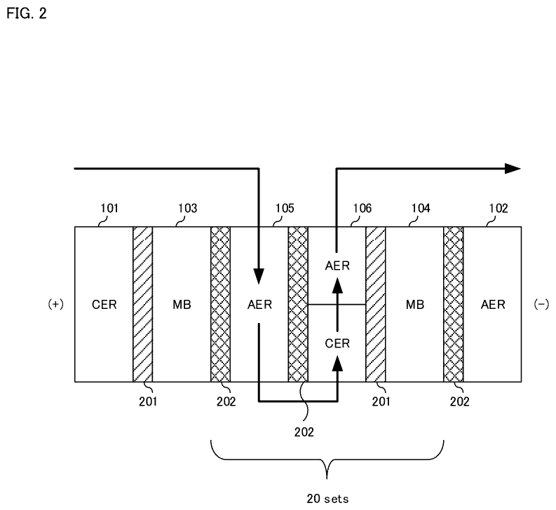

FIG. 2 is a diagram showing an example of the structure of the EDI devices shown in FIG. 1. As shown in FIG. 2, EDI devices 20-1 and 20-2 shown in FIG. 1 each include anode chamber 101 filled with cation exchange resin (CER), cathode chamber 102 filled with anion exchange resin (AER), concentration chambers 103 and 104 that have mixed beds (MB) filled with a cation exchange resin and an anion exchange resin, first desalination chamber 105 filled with an anion exchange resin, and second desalination chamber 106 filled with both a cation exchange resin and an anion exchange resin in that order from the upstream direction. Anode chamber 101 and concentration chamber 103 are adjacent to each other with cation exchange membrane 201 interposed. Concentration chamber 103 and first desalination chamber 105 are adjacent to each other with anion exchange membrane 202 interposed. First desalination chamber 105 and second desalination chamber 106 are adjacent to each other with anion exchange membrane 202 interposed. Second desalination chamber 106 and concentration chamber 104 are adjacent to each other with cation exchange membrane 201 interposed. Concentration chamber 104 and cathode chamber 102 are adjacent to each other with anion exchange membrane 202 interposed. Anode chamber 101 may also serve as concentration chamber 103 without cation exchange membrane 201 arranged between anode chamber 101 and concentration chamber 103. Cathode chamber 102 may also serve as concentration chamber 104 without anion exchange membrane 202 arranged between cathode chamber 102 and concentration chamber 104.

Table 2 shows the results of the water flow operation for the Category A embodiment shown in FIG. 1. An extra low-pressure RO membrane produced as XLE-440 by Dupont was used for each of RO membrane devices 10-1 and 10-2. Three elements were arranged in parallel in each of RO membrane devices 10-1 and 10-2, and water was caused to flow through each of RO membrane devices 10-1 and 10-2. RO membrane device 10-1 and RO membrane device 10-2 were operated such that the permeate flow rates were 3.5 m³/h and 3.10 m³/h, respectively. In each of EDI devices 20-1 and 20-2, an EDI stack for high purity consisting of 20 sets having the basic configuration shown in FIG. 2 of anion exchange membrane 202, first desalination chamber 105, anion exchange membrane 202, second desalination chamber 106, cation exchange membrane 201, and concentration chamber 104, and operation was carried out under the high flow rate and high current conditions shown below. For EDI device 20-1, which was the first EDI device, the flow rate per ion exchange resin volume (SV) in first desalination chamber 105 or second desalination chamber 106 was 440 h⁻¹, the current density was 1.2 A/dm², and the differential pressure in the desalination chamber was from 0.22±0.02 MPa. For EDI device 20-2, which was the second EDI device, the flow rate per ion exchange resin volume (SV) in first desalination chamber 105 or second desalination chamber 106 was 400 h⁻¹, the current density was 1.2 A/dm², and the differential pressure in the desalination chamber was 0.20±0.02 MPa. The high flow rate condition for the EDI stacks means that the water passed through the EDI devices 20-1 and 20-2 such that the flow rate per ion exchange resin volume (SV) in first desalination chamber 105 or second desalination chamber 106 was between 300 and 450 h⁻¹. The high current condition for the EDI stack means that a current with a current density of from 0.8 to 1.2 A/dm² was applied to EDI devices 20-1 and 20-2. The high flow rate and high current conditions of the EDI stack are the conditions under which the water was passed such that the water flow differential pressure in the desalination chamber was from 0.18 to 0.3 MPa. The water was passed through EDI devices 20-1 and 20-2 such that the flow rate (SV) per ion exchange resin volume in first desalination chamber 105 or second desalination chamber 106 was 350 to 450 h⁻¹. A current with a current density of from 0.7 to 1.4 A/dm² was applied to EDI devices 20-1 and 20-2. The water was passed through the desalination chamber such that the water flow differential pressure was from 0.18 to 0.3 MPa.

TABLE 2

| | Water supplied | Treated water | Treated water |
|---|---|---|---|
| | to EDI | by 1st EDI | by 2nd EDI |
| | Category A | (for high purity) | (for high purity) |
| Conductivity | 3.2 | — | — |
| (μS/cm) | | | |
| Resistivity | — | 17.8 | 18.2 |
| (MΩ · cm) | | | |
| Boron | 100 | 0.7 | <0.001 |
| (μg/L) | | (99.30%) | (99.86% or more) |
| Silica | 50 | <0.1 | — |
| (μg/L) | | | |
| Hardness | 0.05 | <0.005 | — |
| (mgCaCO₃/L) | | | |

As shown in Table 2, even for category A for which the water supplied to the EDI devices is assumed to be RO-treated water that has undergone treatment using two stages of extra low-pressure RO membrane devices, water treatment using two stages of EDI devices for high purity in the present working example was able to reduce the boron concentration to less than 1 ng/L, which is the level of ultrapure water required by state-of-the-art semiconductor manufacturers.

### Second Embodiment

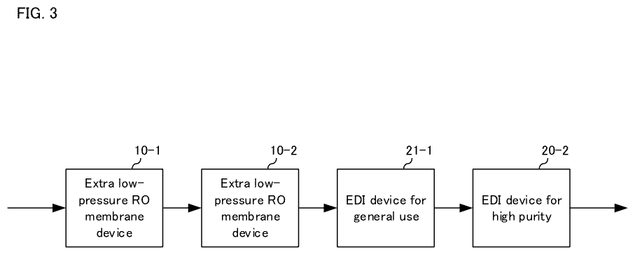

FIG. 3 is a diagram showing a second embodiment of a water treatment system of the present invention. In this embodiment, RO membrane devices 10-1 and 10-2 and EDI devices 21-1 and 20-2 are connected in series as shown in FIG. 3. RO membrane devices 10-1 and 10-2 and EDI device 20-2 are each the same as those in the first embodiment. EDI device 21-1 is an EDI device for general use. Raw water is supplied to RO membrane device 10-1 shown in FIG. 3, and the supplied raw water is treated in each of RO membrane devices 10-1 and 10-2 and EDI devices 21-1 and 20-2.

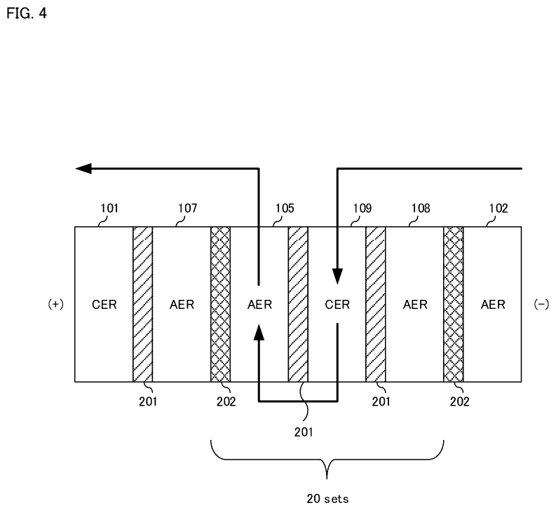

FIG. 4 is a diagram showing an example of the structure of the EDI device for general use shown in FIG. 3. As shown in FIG. 4, EDI device 21-1 shown in FIG. 3 has anode chamber 101 filled with a cation exchange resin, cathode chamber 102 filled with an anion exchange resin, concentration chambers 107 and 108 filled with an anion exchange resin, first desalination chamber 105 filled with an anion exchange resin, and second desalination chamber 109 filled with a cation exchange resin. Anode chamber 101 and concentration chamber 107 are adjacent to each other with cation exchange membrane 201 interposed. Concentration chamber 107 and first desalination chamber 105 are adjacent to each other with anion exchange membrane 202 interposed. First desalination chamber 105 and second desalination chamber 109 are adjacent to each other with cation exchange membrane 201 interposed. Second desalination chamber 109 and concentration chamber 108 are adjacent to each other with cation exchange membrane 201 interposed. Concentration chamber 108 and cathode chamber 102 are adjacent to each other with anion exchange membrane 202 interposed. Anode chamber 101 may also serve as concentration chamber 107 without cation exchange membrane 201 interposed between anode chamber 101 and concentration chamber 107. Cathode chamber 102 may also serve as concentration chamber 108 without anion exchange membrane 202 interposed between cathode chamber 102 and concentration chamber 108.

Table 3 shows the results of the water flow operation for the Category A embodiment shown in FIG. 3. The operating conditions for each device are the same as in the first embodiment.

TABLE 3

| | Water supplied | Treated water | Treated water |
|---|---|---|---|
| | to EDI | by 1st EDI | by 2nd EDI |
| | Category A | (for general use) | (for high purity) |
| Conductivity | 3.3 | — | — |
| (μS/cm) | | | |
| Resistivity | — | 17.8 | 18.2 |
| (MΩ · cm) | | | |
| Boron | 100 | 2.8 | 0.017 |
| (μg/L) | | (97.20%) | (99.39% or more) |
| Silica | 40 | 0.4 | <0.1 |
| (μg/L) | | | |
| Hardness | 0.04 | <0.005 | — |
| (mgCaCO₃/L) | | | |

As shown in Table 3, even for Category A water supplied to an EDI that is assumed to be RO-treated water that has undergone treatment using two stages of extra low-pressure RO membrane devices, water treatment using a combination of an EDI device for general use and an EDI device for high purity can reduce the ultrapure water boron concentration level to less than 50 ng/L, which is the level of the predetermined standard required by the International Roadmap for Devices and Systems (IRDS).

### Third Embodiment

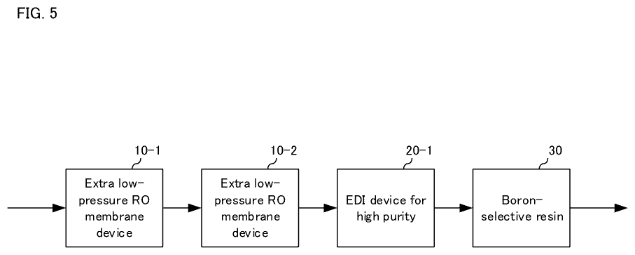

FIG. 5 is a diagram showing a third embodiment of a water treatment system of the present invention. In this embodiment, RO membrane devices 10-1 and 10-2, EDI device 20-1, and boron-selective resin 30 are connected in series, as shown in FIG. 5. RO membrane devices 10-1 and 10-2 and EDI device 20-1 are each the same as those in the first embodiment. Boron-selective resin 30 is a device that selectively removes boron from the supplied liquid. Boron-selective resin 30 has functional groups that react specifically with boron and can selectively remove boron. Boron-selective resin 30 is not limited to a material that can selectively adsorb boron. As boron-selective resin 30, an ion exchange resin with a polyvalent alcohol group introduced as a functional group is used. In particular, boron-selective resin 30 should have an N-methylglucamine group, which is a functional group with high selectivity for boron. For example, boron-selective resins 30 include Amberlite IRA743 (produced by Dupont) and DIAION CRB03 (produced by Mitsubishi Chemical Corporation). Raw water is supplied to RO membrane device 10-1 shown in FIG. 5, and the supplied raw water is treated in each of RO membrane devices 10-1 and 10-2, EDI device 20-1, and boron selective resin 30.

Table 4 shows the results of the water-flow operation for the Category A embodiment shown in FIG. 5. The operating conditions for each device are the same as in the first embodiment.

TABLE 4

| | Water supplied | Treated water | Boron-selective |
|---|---|---|---|
| | to EDI | by 1st EDI | resin |
| | Category A | (for high purity) | treated water |
| Conductivity | 3.2 | — | — |
| (μS/cm) | | | |
| Resistivity | — | 17.8 | — |
| (MΩ · cm) | | | |
| Boron | 100 | 0.7 | <0.001 |
| (μg/L) | | (99.30%) | (99.85% or more) |
| Silica | 50 | <0.1 | — |
| (μg/L) | | | |
| Hardness | 0.05 | <0.005 | — |
| (mgCaCO₃/L) | | | |

As shown in Table 4, in the present embodiment, even for Category A in which the water supplied to the EDI device is assumed to have undergone RO treatment using two stages of extra low-pressure RO membrane devices, by providing a single EDI device for high-purity to follow the latter RO membrane device and further providing a boron-selective resin after the EDI device, the boron concentration can be reduced to the level of ultrapure water (less than 1 ng/L) that is required of ultrapure water by state-of-the-art semiconductor manufacturers.

### Fourth Embodiment

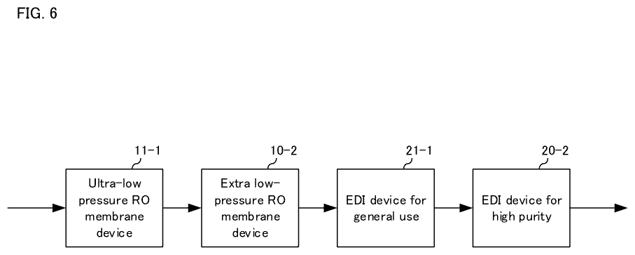

FIG. 6 is a diagram showing a fourth embodiment of a water treatment system of the present invention. As shown in FIG. 6, in this embodiment, RO membrane devices 11-1 and 10-2 and EDI devices 21-1 and 20-2 are connected in series. RO membrane device 10-2 and EDI device 20-2 are each the same as in the first embodiment. EDI device 21-1 is the same as in the second embodiment. RO membrane device 11-1 is equipped with an ultra-low pressure RO membrane. RO membrane device 11-1 is, for example, an ultra-low pressure RO membrane (SG30LE-440i) produced by Dupont. Raw water is supplied to RO membrane device 11-1 shown in FIG. 6, and the supplied raw water is treated in each of RO membrane devices 11-1 and 10-2 and EDI devices 21-1 and 20-2.

Table 5 shows the results of the water flow operation for the Category B embodiment shown in FIG. 6. The operating conditions for each device are the same as in the first embodiment.

TABLE 5

| | Water supplied | Treated water | Treated water |
|---|---|---|---|
| | to EDI | by 1st EDI | by 2nd EDI |
| | Category B | (for general use) | (for high purity) |
| Conductivity | 2.9 | — | — |
| (μS/cm) | | | |
| Resistivity | — | 17.9 | 18.2 |
| (MΩ · cm) | | | |
| Boron | 26 | 0.5 | <0.001 |
| (μg/L) | | (98.08%) | (99.80% or more) |
| Silica | 50 | <0.1 | — |
| (μg/L) | | | |
| Hardness | 0.05 | <0.005 | — |
| (mgCaCO₃/L) | | | |

As shown in Table 5, in the present embodiment, even for category B in which the water supplied to an EDI device is assumed to have undergone RO treatment using two stages of an ultra-low pressure RO membrane device and an extra low-pressure RO membrane device, by carrying out water treatment by combining an EDI device for general use and an EDI device for high purity, the boron concentration can be reduced to the level of ultrapure water (less than 1 ng/L) that is required of ultrapure water by state-of-the-art semiconductor manufacturers.

### Comparative Example 1

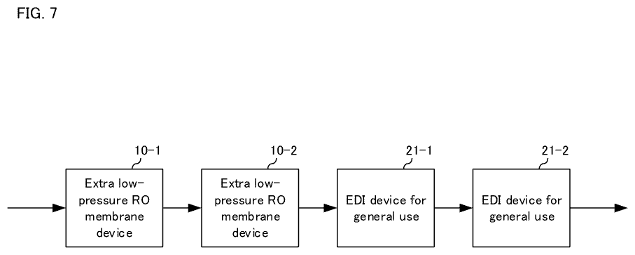

FIG. 7 is a diagram showing a first comparative example for comparison with the above-described embodiments. As shown in FIG. 7, in this example, RO membrane devices 10-1 and 10-2 and EDI devices 21-1 and 21-2 are connected in series. RO membrane devices 10-1 and 10-2 are each the same as the devices in the first embodiment. EDI devices 21-1 and 21-2 are each the same as EDI device 21-1 in the second embodiment. Raw water is supplied to RO membrane device 10-1 shown in FIG. 7, and the supplied raw water is treated in RO membrane devices 10-1 and 10-2 and EDI devices 21-1 and 21-2.

Table 6 shows the results of the water flow operation for the Category A embodiment shown in FIG. 7. Three elements were arranged in parallel in each of RO membrane devices 10-1 and 10-2, water was passed through the devices, and operation was carried out such that the permeate flow rate of RO membrane device 10-1 was 3.5 m³/h and the permeate flow rate of RO membrane device 10-2 was 3.10 m³/h. For each of EDI devices 21-1 and 21-2, an EDI stack for high purity was used consisting of 20 sets of the basic configuration of concentration chambers 107 and 108, first desalination chamber 105, and second desalination chamber 109 shown in FIG. 4, and operation was carried out using the following high flow rate and high current conditions: for first EDI device 21-1, operation was carried out with the flow rate per ion exchange resin volume (SV) in first desalination chamber 105 or second desalination chamber 109 at 440 h⁻¹, the current density at 1.0 A/dm², and the differential pressure in the desalination chamber at 0.22±0.02 MPa; and for second EDI device 21-2, operation was carried out with the flow rate per ion exchange resin volume (SV) in first desalination chamber 105 or second desalination chamber 109 at 400 h⁻¹, the current density at 1.0 A/dm², and the differential pressure in the desalination chamber at 0.20±0.02 MPa.

TABLE 6

| | Water supplied | Treated water | Treated water |
|---|---|---|---|
| | to EDI | by 1st EDI | by 2nd EDI |
| | Category A | (for general use) | (for general use) |
| Conductivity | 3.2 | — | — |
| (μS/cm) | | | |
| Resistivity | — | 17.8 | 18.1 |
| (MΩ · cm) | | | |
| Boron | 100 | 2.8 | 0.06 |
| (μg/L) | | (97.20%) | (97.86% or more) |
| Silica | 40 | 0.4 | <0.1 |
| (μg/L) | | | |
| Hardness | 0.04 | <0.005 | — |
| (mgCaCO₃/L) | | | |

As shown in Table 6, in this comparative example, the concentration of boron in the treated water in final-stage EDI device 21-2 was 0.06 μg/L, which means that boron could not be sufficiently removed from the raw water, and the boron concentration could not be reduced to the boron concentration level (less than 50 ng/L) of ultrapure water required as a prescribed standard.

### Comparative Example 2

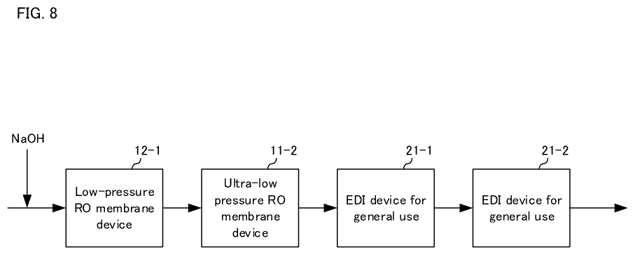

FIG. 8 is a diagram showing a second comparative example for comparison with the embodiments. In this example, RO membrane devices 12-1 and 11-2 and EDI devices 21-1 and 21-2 were connected in series as shown in FIG. 8. RO membrane device 12-1 was equipped with a low-pressure RO membrane. RO membrane device 12-1 was, for example, a CR100 produced by Dupont. RO membrane device 11-2 was the same as RO membrane device 11-1 in the fourth embodiment. EDI devices 21-1 and 21-2 were each the same as EDI device 21-1 in the second embodiment. Raw water was supplied to RO membrane device 12-1 shown in FIG. 8, and the supplied raw water was treated in each of RO membrane devices 12-1 and 11-2 and EDI devices 21-1 and 21-2. A prescribed amount of sodium hydroxide was added to the raw water supplied to RO membrane device 12-1.

Table 7 shows the results of the water flow operation for the Category C embodiment shown in FIG. 8. Three elements were arranged in parallel in each of RO membrane devices 12-1 and 11-2, water was passed through the devices, and operation was carried out in RO membrane device 10-1 and RO membrane device 10-2 such that the permeate flow rate of RO membrane device 12-1 was 3.5 m³/h and the permeate flow rate of RO membrane device 11-2 was 3.10 m³/h. For each of EDI devices 21-1 and 21-2, an EDI stack for high purity was used consisting of 20 sets of the basic configuration of concentration chambers 107 and 108, first desalination chamber 105, and second desalination chamber 109 shown in FIG. 4, and operation was carried out using the following high flow rate and high current conditions: the first EDI device 21-1 was operated with the flow rate per ion exchange resin volume (SV) in first desalination chamber 105 or second desalination chamber 109 at 440 h⁻¹, the current density at 1.0 A/dm², and the differential pressure in the desalination chamber at 0.22±0.02 MPa; and the second EDI device 21-2 was operated with the flow rate per ion exchange resin volume (SV) in first desalination chamber 105 or second desalination chamber 109 at 400 h⁻¹, the current density at 1.0 A/dm², and the differential pressure in the desalination chamber at 0.20±0.02 MPa.

TABLE 7

| | Water supplied | Treated water | Treated water |
|---|---|---|---|
| | to EDI | by 1st EDI | by 2nd EDI |
| | Category C | (for general use) | (for general use) |
| Conductivity | 1.1 | — | — |
| (μS/cm) | | | |
| Resistivity | — | 18.0 | 18.1 |
| (MΩ · cm) | | | |
| Boron | 10 | 0.2 | 0.04 |
| (μg/L) | | (98.00%) | (80.00% or more) |
| Silica | 5 | <0.1 | — |
| (μg/L) | | | |
| Hardness | <0.005 | — | — |
| (mgCaCO₃/L) | | | |

As shown in Table 7, in this comparative example, even though the boron concentration was sufficiently reduced by RO membrane devices 12-1 and 11-2, in the water treatment in the two-stage configuration of EDI devices 21-1 and 21-2 for general use that follow the RO membrane devices, the boron concentration in the treated water was 0.04 μg/L, a level that meets the prescribed standard required by IRDS but that exceeds the 1 ng/L limit demanded by state-of-the-art semiconductor manufacturers. In particular, the removal rate of boron was confirmed to be significantly reduced when an EDI for general use was used in the second-stage EDI device.

In the example described above, a feed pump that boosts the pressure of the feed water was used to supply (conduct) water to the RO membrane devices and EDI devices. The power consumption per unit process flow rate was calculated based on the power requirements of the feed pumps, which were calculated based on the throughput pressure of the extra low-pressure RO membranes, ultra-low pressure RO membranes, and low-pressure RO membranes, and on the operating current and operating voltage of the EDI devices for general use and the EDI devices for high purity, and the rates of increase or decrease for each system were compared. Table 8 shows the percentage reduction in power consumption for each embodiment taking as a reference the value of power consumption in the second comparative example (set as 0 for the rate of increase or decrease).

TABLE 8
Reduction in power consumption of RO-EDI

| | |
|---|---|
| Example 1 | −28% |
| Example 2 | −32% |
| Example 3 | −35% |
| Example 4 | −25% |
| Comparative Example 1 | −35% |
| Comparative Example 2 | Reference (0%) |

As shown in Table 8, based on the values in the second comparative example, employing an RO membrane device equipped with an extra low-pressure RO membrane enables a 25 to 35% reduction of the operational power consumption of RO-EDI compared to employing a device equipped with a low-pressure membrane or ultra-low pressure RO membrane. An EDI device for high purity tends to consume more power than an EDI device for general use due to the purpose of removing boron to a higher degree than an EDI device for general use. On the other hand, the power consumption of an EDI device for high purity can be reduced to about 1.5 times the power consumption of an EDI device for general use by properly managing the operation of the RO membrane device to keep the silica concentration and hardness low, these factors being the cause of increase of the voltage of EDI devices. In addition, using an extra low-pressure RO membrane has the effect of reducing power consumption and can thus reduce the power consumption of the overall system.

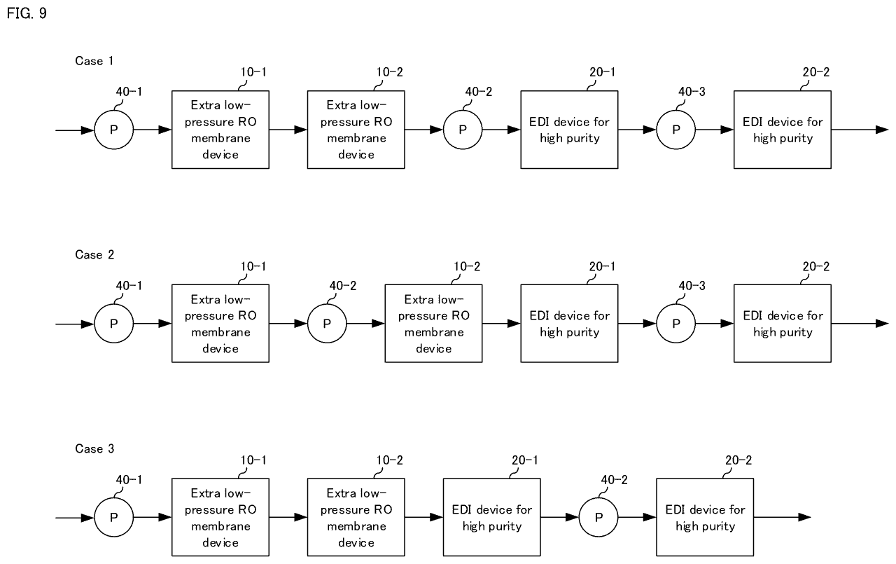

The feed pump arrangement in the water treatment system is next described. FIG. 9 is a diagram showing an example of the arrangement of pumps in a water treatment system of the present invention. FIG. 9 shows three examples of arrangements in cases 1 to 3. RO membrane devices 10-1 and 10-2 and EDI devices 20-1 and 20-2 in each case are the same as the components in the first embodiment. In case 1, first pump 40-1 is arranged to precede RO membrane device 10-1. Second pump 40-2 is arranged between RO membrane device 10-2 and EDI device 20-1. Third pump 40-3 is arranged between EDI device 20-1 and EDI device 20-2. In Case 2, first pump 40-1 is arranged to precede RO membrane device 10-1. Second pump 40-2 is arranged between RO membrane device 10-1 and RO membrane device 10-2. Third pump 40-3 is arranged between EDI device 20-1 and EDI device 20-2. In Case 3, first pump 40-1 is arranged to precede RO membrane device 10-1. Second pump 40-2 is arranged between EDI device 20-1 and EDI device 20-2.

In the above-described embodiments, employing an RO membrane device equipped with an extra low-pressure RO membrane reduces the differential pressure in the RO membrane and allows water to pass through two or more constituent elements (RO membrane devices or EDI devices) arranged together in series using a single pump. Other components (tanks, UV irradiators, degassing membranes, etc.) may be arranged between each of the constituent elements.

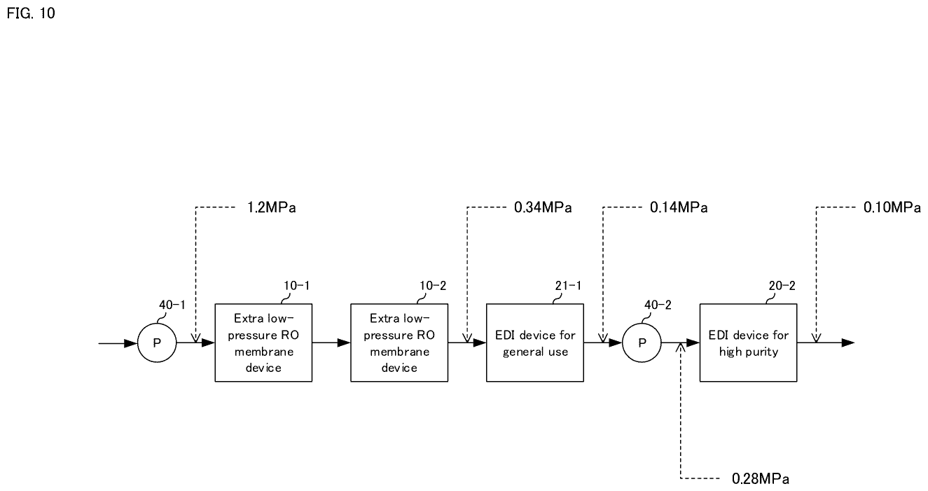

FIG. 10 is a diagram showing pressure values at each point in the embodiment shown in FIG. 3. Here, first pump 40-1 is arranged to precede RO membrane device 10-1. Second pump 40-2 is arranged between EDI device 21-1 and EDI device 20-2. In other words, first pump 40-1 is used to convey water from RO membrane device 10-1 to EDI device 21-1. Water that has undergone treatment by EDI device 21-1 is boosted by pump 40-2 to pass through EDI device 20-2. In this configuration, the pressure value at the point between pump 40-1 and RO membrane device 10-1 is 1.2 MPa. The pressure value at the point between RO membrane device 10-2 and EDI device 21-1 is 0.34 MPa. The pressure value at the point between EDI device 21-1 and pump 40-2 is 0.14 MPa. The pressure value at the point between pump 40-2 and EDI device 20-2 is 0.28 MPa. The pressure value at the point following EDI device 20-2 is 0.10 MPa. Because an EDI device has a higher flow rate, the differential pressure of EDI device 21-1 is 0.2 MPa and that of EDI device 20-2 is 0.18 MPa. However, the system can be operated without a pump preceding EDI device 21-1; i.e., between RO membrane device 10-2 and EDI device 21-1. Pump 40-2 arranged between EDI device 21-1 and EDI device 20-2 can also be arranged between RO membrane device 10-2 and EDI device 21-1. However, in this arrangement, a large supply pressure must be added to EDI device 21-1 because the differential pressure of EDI device 20-2 is added to the differential pressure of EDI device 21-1. This means that pump 40-2 bears the significant burden of supplying water pressure to both EDI device 21-1 and EDI device 20-2. An EDI device has lower pressure resistance performance than an RO membrane device, and an EDI device is therefore preferably operated at 0.5 MPa or less. To achieve a supply water pressure of 0.28 MPa to EDI device 20-2 as shown in FIG. 10, the supply water pressure of EDI device 21-1 must be at least 0.48 MPa. If a certain amount of margin is taken into consideration, this arrangement is not necessarily preferable.

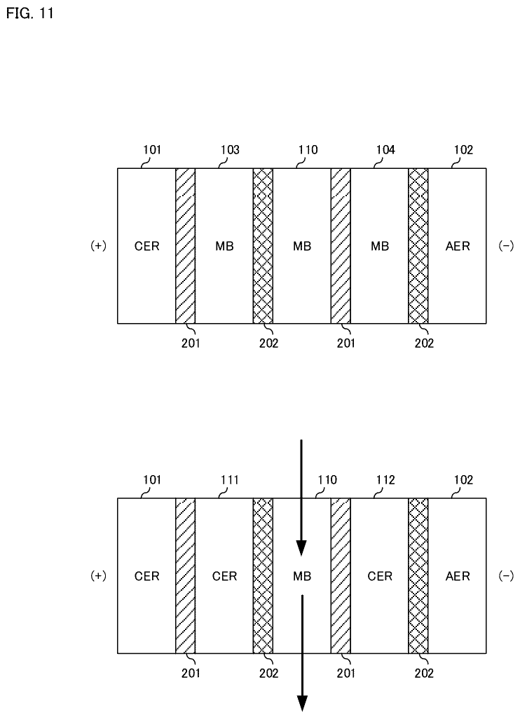

FIG. 11 is a diagram showing another example of the structure of an EDI device for high purity used in the present invention. Although examples of structures of EDI devices for high purity used in this invention have been shown in FIGS. 2 and 4, two additional examples are shown in FIG. 11. The structure shown in the upper part of FIG. 11 is provided with anode chamber 101 filled with a cation exchange resin, cathode chamber 102 filled with an anion exchange resin, concentration chambers 103 and 104 that are mixed beds filled with a cation exchange resin and an anion exchange resin, and first desalination chamber 110 that is a mixed bed filled with a cation exchange resin and an anion exchange resin. Anode chamber 101 and concentration chamber 103 are adjacent to each other via cation exchange membrane 201. Concentration chamber 103 and first desalination chamber 110 are adjacent to each other via anion exchange membrane 202. First desalination chamber 110 and concentration chamber 104 are adjacent to each other via cation exchange membrane 201. Concentration chamber 104 and cathode chamber 102 are adjacent to each other via anion exchange membrane 202. The structure shown in the lower part of FIG. 11 is provided with anode chamber 101 filled with a cation exchange resin, cathode chamber 102 filled with an anion exchange resin, concentration chambers 111 and 112 filled with a cation exchange resin, and first desalination chamber 110 that is a mixed bed filled with a cation exchange resin and an anion exchange resin. Anode chamber 101 and concentration chamber 111 are adjacent to each other via cation exchange membrane 201. Concentration chamber 111 and first desalination chamber 110 are adjacent to each other via anion exchange membrane 202. First desalination chamber 110 and concentration chamber 112 are adjacent to each other via cation exchange membrane 201. Concentration chamber 112 and cathode chamber 102 are adjacent to each other via anion exchange membrane 202. Thus, in an EDI device for high purity, the bottom layer of the desalination chamber is filled with at least an anion exchange resin, and the adjacent concentration chamber via the cation exchange membrane that partitions the desalination chamber is filled with at least a cation exchange resin. The desalination chamber may be filled only with an anion exchange resin. Multiple basic configurations can also be stacked as described in the first and second embodiments. This form increases the amount of water that can be treated. Furthermore, anode chamber 101 can also serve as concentration chambers 103 and 111 without cation exchange membrane 201 arranged between anode chamber 101 and concentration chambers 103 and 111. Cathode chamber 102 may also serve as concentration chambers 104 and 112 without anion exchange membrane 202 arranged between cathode chamber 102 and concentration chambers 104 and 112. As the conditions for high flow for the EDI stack in the configuration shown in FIG. 11, the water must pass through desalination chamber 110 such that the flow rate per ion exchange resin volume (SV) is between 300 to 450 h⁻¹.

An EDI device, by being energized with DC current, can continuously regenerate electricity. Therefore, compared to other ion exchange resin devices, EDI devices have a faster flow rate per resin volume (SV) and are generally operated at flow rates of 150 to 250 h⁻¹ with a water flow differential pressure of about 0.09 to 0.15 MPa. Increasing the flow rate of such EDI device to a higher rate was investigated and operation of the device at a rate more than 1.5 times higher than that of a conventional device was also tested. As a result, the water flow differential pressure also increased by more than 1.5 times, and the pressure required to supply water to the EDI device also increased. In addition, employing a device equipped with an extra low-pressure RO membrane in the present invention reduced the pressure loss of the RO membrane device, eliminating the need to install supply (pressure-boosting) pumps and tanks between the components that make up the system. In addition, eliminating the addition of chemicals to adjust the pH of the target water enabled reduced costs for chemicals, eliminated the need for equipment for adding chemicals, and reduced management expenses. In addition, the RO membrane device is operated such that the silica concentration and hardness in the water permeating the RO membrane are below a certain concentration, which is a cause of increased electrical resistance of the EDI device. This allows an increase of the current while reducing the voltage increase in the EDI device, thereby obtaining treated water having higher purity. In addition, employing a device equipped with an extra low-pressure RO membrane enables a significant reduction of power consumption. Thus, the present invention can provide a water treatment system with low energy consumption and low management costs. The boron removal rate can therefore be improved without significant load.

While the present invention has been described with reference to the embodiments, the present invention is not limited to the above embodiments. Various changes can be made in the configuration and details of the present invention within the scope of the present invention that will be understood by those skilled in the art.

This application claims priority based on JP 2022-138237, filed Aug. 31, 2022, and incorporates herein all of the disclosures of that application.

1. A water treatment system for removing at least boron from treated water, comprising:
an RO membrane device that includes an extra low-pressure RO membrane; and,
an EDI device that is arranged to follow the RO membrane device and that includes an EDI stack for high purity in which a lowermost layer of a desalination chamber is filled with at least an anion exchange resin and an adjacent concentration chamber via a cation exchange membrane that partitions the desalination chamber is filled with at least a cation exchange resin, wherein
the RO membrane device includes RO membrane devices in two stages and the extra low-pressure RO membrane is arranged at least in one of the first and second stages.

2. The water treatment system according to claim 1, wherein
the EDI device includes EDI devices in two stages and the EDI stack for high purity is arranged in at least one of the first and second stages.

3. The water treatment system according to claim 2, comprising:
a plurality of pumps for conveying the treated water to the RO membrane device and the EDI device, wherein
at least one of the plurality of pumps is arranged to supply the treated water to two or more of the RO membrane devices and EDI devices that are arranged together in series.

4. The water treatment system according to claim 1, wherein
the extra low-pressure RO membrane is a membrane that has a permeate flow rate per unit pressure and unit area (per 1 MPa of supply pressure and 1 m² of membrane area) of at least 1.3 (m³/d)/(m2·MPa) and a salt removal rate of less than 99.4% when measured under conditions in which NaCl concentration in the raw liquid is from 500 to 2000 mg/L, pH value is from 6 to 8, water temperature is 25° C., and permeate recovery rate is 10 to 25%.

5. A water treatment method for removing at least boron from treated water, the method comprising:
operating RO membrane devices that include an extra low-pressure RO membrane device that is installed to precede an EDI device that includes an EDI stack for high purity such that boron concentration of treated water supplied to the EDI device is from 20 to 100 μg/L, silica concentration is 50 μg/L or less, and hardness is 0.05 mgCaCO₃/L or less.

6. The water treatment method according to claim 5, wherein
water passes through a desalination chamber of the EDI device that includes the EDI stack for high purity at a flow rate of from 350 to 450 h⁻¹ per ion exchange resin volume of ion exchange resin that fills the desalination chamber.

7. The water treatment method according to claim 6, wherein
water passes through the desalination chamber such that the water flow differential pressure is from 0.18 to 0.3 MPa.

8. The water treatment method according to claim 5, wherein
a current with a current density of from 0.8 to 1.2 A/dm² is applied to the EDI device that includes the EDI stack for high purity.
